(19) United States
(12) Patent Application Publication
(10) Pub. No.: US 2017/0317978 A1
(43) Pub. Date: Nov. 2, 2017

(54) SECURE INTERFACE ISOLATION

(71) Applicant: Microsoft Technology Licensing, LLC, Redmond, WA (US)

(72) Inventors: Gerardo Diaz-Cuellar, Kirkland, WA (US); Aman Arneja, Bellevue, WA (US); Benjamin M. Schultz, Bellevue, WA (US)

(73) Assignee: Microsoft Technology Licensing, LLC

(21) Appl. No.: 15/199,325

(22) Filed: Jun. 30, 2016

Related U.S. Application Data
(60) Provisional application No. 62/329,126, filed on Apr. 28, 2016.

(51) Int. Cl. H04L 29/06

(52) U.S. Cl. CPC H04L 63/0263; H04L 63/0272

(57) ABSTRACT

Techniques for isolating interfaces of a protocol stack are discussed herein. In some instances, an apparatus may store a firewall policy that defines a set of rules for a component or type of component of a layer of a protocol stack, such as an Internet Protocol (IP) interface(s), an IP address(es), a TCP port(s), a socket(s), an application(s), a virtual network interface(s), an interface associated with a Virtual Private Network (VPN), and so on. The apparatus may include a firewall configured to implement the firewall policy at the layer of the protocol stack when data traffic is received at the layer. In some instances, the apparatus may include a monitor module to determine environmental context associated with the device, such as a geo-location of the apparatus or a connection of the apparatus to a network. The firewall may select a firewall policy that is applicable to the environmental context.

### RELATED APPLICATIONS

This application claims the benefit of U.S. Provisional Applicant No. 62/329,126, filed Apr. 28, 2016, the entire contents of which are incorporated herein by reference.

### BACKGROUND

Firewalls are used in many systems to control incoming and outgoing traffic to a network, such as the Internet or another external network. The firewalls operate according to a set of rules that are specified by administrators and others. For example, an administrator of a company may manually define specific rules for outbound traffic and specific rules for incoming traffic in order to maintain a secure environment for employee computers, business servers, and other devices. As various administrators maintain a network over time, hundreds or even thousands of rules are defined, added, and deleted for a firewall to address every possible attack variation in a changing security landscape. For example, hundreds of rules may be defined for specific Internet Protocol (IP) addresses to block network traffic to those specific IP addresses. Further, hundreds of rules may be defined for specific Transmission Control Protocol (TCP) ports, to allow network traffic to only those ports. As such, firewalls are often associated with extensive and complex policies (e.g., multiple if-then rules, hundreds or thousands or rules, etc.). It is not uncommon for these policies to include inconsistent rules, which can increase the attack surface of a network, add administrative maintenance burden on an enterprise, and/or negatively impact performance of the firewall. For instance, a firewall policy could specify allow subnet 123.123.0.0/16, block subnet 123.123.1.0/24, and allow IP address 123.123.1.5. Here, the firewall has to parse the whole ruleset to figure out what the policy is and each entry is embedded in an earlier one.

### SUMMARY

The techniques discussed herein are directed to isolating interfaces of a protocol stack. In many instances, an apparatus may store a firewall policy that defines a set of rules for a component or type of component of a layer of a protocol stack, such as an Internet Protocol (IP) interface(s), an IP address(es), a TCP port(s), a socket(s), an application(s), a virtual network interface(s), an interface associated with a Virtual Private Network (VPN), and so on. The apparatus may include a firewall configured to implement the firewall policy at the layer of the protocol stack when data traffic is received at the layer. In some instances, the apparatus may include a monitor module to determine environmental context associated with the apparatus. The firewall may select a firewall policy that is applicable to the environmental context. The environmental context may include a geo-location of the apparatus or a connection of the apparatus to a network.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, can refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an example architecture in which techniques described herein may be implemented.

FIG. 2 illustrates example details of a device of FIG. 1.

FIG. 3 shows example isolation systems in which the techniques discussed herein may be implemented.

FIG. 4 illustrates an example process to control data traffic based on a policy that includes a set of rules that are applicable to a particular component(s) of a layer of a protocol stack.

FIG. 5 illustrates an example process to generate a policy that includes a set of rules that are applicable to a particular component(s) of a layer of a protocol stack.

### DETAILED DESCRIPTION

This disclosure is directed to techniques to isolate interfaces of a protocol stack. In many instances, a firewall may control data traffic according to a policy that is specific to a particular component(s) or type of component of a protocol layer. For example, the policy may include a group of rules for a particular Internet Protocol (IP) interface within a network layer of a protocol stack. The firewall may implement the policy to control (e.g., allow, deny, etc.) data traffic through the particular IP interface. In many instances, the techniques discussed herein provide a policy model that unifies and/or streamlines firewall implementation. That is, by using a policy that is tied to a specific component(s) or type of component of a protocol stack, the firewall may implement a unified and/or streamlined rule construct. This may streamline policy maintenance for a firewall (improving consistency and security), increase network performance (e.g., by avoiding complex and/or extensive rule constructs and associated lookup times), and so on.

In one illustration, a policy may be created such that the policy can be tied to IP interfaces of a device. For example, IP interfaces are associated with different types of Network Interface Controllers (NICs), virtual network interfaces (e.g. VPN, network virtualizations, etc.), or the like. For instance, the policy may include a first group of rules for an IP interface associated with an Ethernet NIC and an IP interface associated with a wireless NIC (e.g., Wi-Fi). The first group of rules may specify that data traffic for the IP interface associated with the Ethernet NIC and the IP interface associated with the wireless NIC is allowed if the data traffic satisfies certain conditions, such as being associated with a particular IP address(es), Transmission Control Protocol (TCP) port(s), application(s), and so on. Further, the policy may include a second group of rules for an IP interface associated with a cellular NIC (e.g., 4G LTE). The second group of rules may specify that data traffic for the IP interface associated with the cellular NIC is allowed if the data traffic satisfies certain conditions, such as being associated with a particular IP address(es), TCP port(s), application(s), and so on. In this illustration, the policy includes rules that are anchored to particular components of the network layer of the protocol stack.

In this illustration, the policy may be deployed to various client devices to control network traffic at the respective client devices. For example, a firewall at a client device may use the policy to control data traffic at the network layer of the client device. This may include blocking, allowing, or otherwise controlling the data traffic for IP interfaces of the device according to the first group of rules and the second group of rules. That is, the IP interface associated with the Ethernet NIC and the IP interface associated with the wireless NIC may be controlled according to the first set of rules, while the IP interface associated with the cellular NIC may be controlled according to the second set of rules. As such, the firewall rules may be tied to the IP interface layer of the protocol stack to control data traffic, resulting in a more streamlined policy model that avoids conflicting rules. In contrast, conventional firewalls operate according to hundreds or thousands of rules for specific IP addresses, ports, subnets, and so on. For instance, conventional techniques may include individual rules for each source/destination IP address pair, TCP ports, and so forth (e.g., rule 1—block network traffic associated with source IP address 104.43.2.1 and destination IP address 204.79.100.2, rule 2—allow network traffic associated with source IP address 104.43.5.5 and destination IP address 204.78.3.5, rule 3—block network traffic associated with source IP address 134.70.2.55 and destination IP address 204.86.55.7, etc.). Rules that are constructed over time to manage security in an ever changing landscape create complexity and are difficult to manage. In many instances, as a rule-set for a firewall becomes more complex the risk of configuration error increases (e.g., an increase in allowing or blocking unintended traffic).

Although the illustration above discusses anchoring a policy to an IP interface of a network layer of a protocol stack, in other illustrations policies are anchored to other components and/or other layers of the protocol stack. For instance, a policy may be anchored to an IP address(es), a TCP port(s), a socket(s), an application(s), a virtual network interface(s), an interface associated with a Virtual Private Network (VPN), and so on. As such, a policy may be anchored to any component of a protocol stack. Alternatively, or additionally, a policy may be anchored to any data type in a data structure. For example, a policy may be tied to a specific geo-location (e.g., so that the policy is implemented when a device is located at the specific geo-location), a specific user (e.g., so that the policy is implemented when the specific user is logged in to the device (based on username or other user identifying information)), and so on.

As noted above, the techniques discussed herein may provide a policy model that unifies and/or streamlines firewall implementation. Such techniques may be used in a variety of contexts. In some instances, by using a unified and/or streamlined policy, a firewall may isolate a system from another system (e.g., isolate a client from a network, isolate a container from a host, isolate a virtual machine from a host, isolate a first system from another system over a Virtual Private Network (VPN), isolate an application from another application, etc.). In other words, by creating a policy that is tied to a component(s) of a layer within a protocol stack (or any other component) and/or implementing the policy when data traffic is received at the layer, the data traffic to or from the component(s) may be controlled according to a unified set of rules. As such, in some instances the techniques may create a layer of isolation for any type of network interface, such as a physical interface, virtual interface, etc.

This brief introduction is provided for the reader's convenience and is not intended to limit the scope of the claims, nor the proceeding sections. Furthermore, the techniques described in detail below may be implemented in a number of ways and in a number of contexts. Example implementations and contexts are provided with reference to the following figures, as described below in more detail. However, the following implementations and contexts are only examples of many.

### Example Architecture

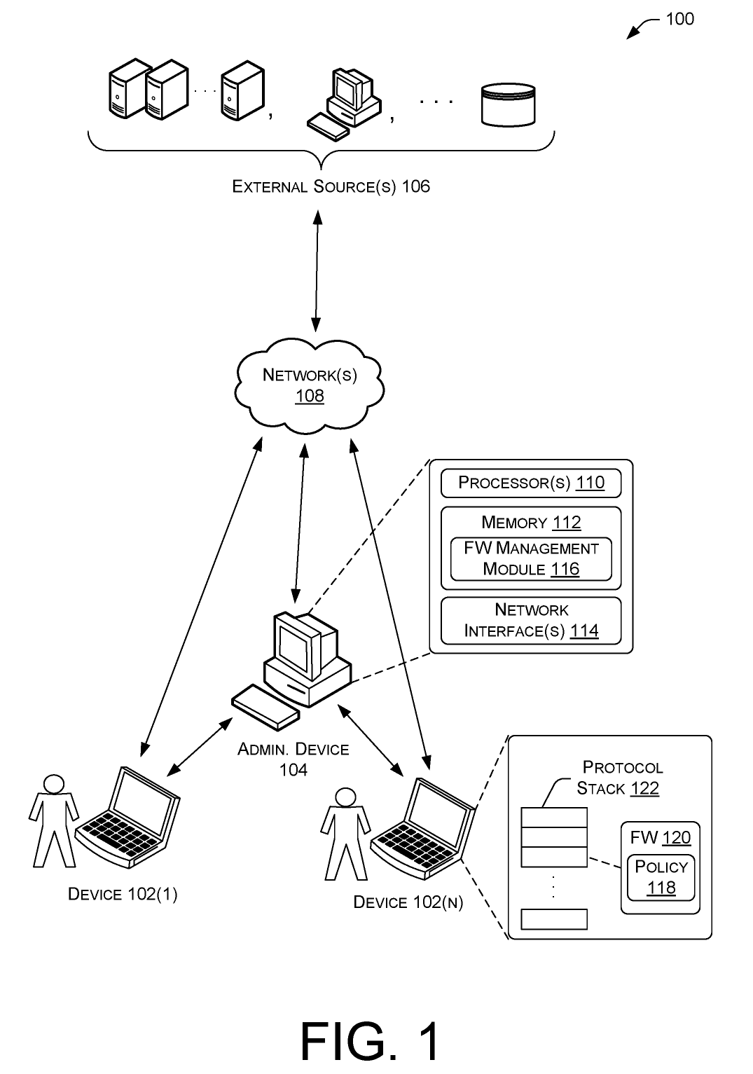

FIG. 1 illustrates an example architecture 100 in which techniques described herein may be implemented. The architecture 100 includes a plurality of devices 102(1)-102(N) (collectively referred to as “the devices 102”) configured to communicate with an administrator device 104 and/or one or more external sources 106 (hereinafter “the external source 106”). N may represent any integer greater than “0.” The external source 106 may include any number of servers, virtual machines, cloud services, devices (which may include any of the devices 102), and so on. In this example, the administrator device 104 manages a policy for the devices 102 by creating the policy and causing the policy to be deployed to the devices 102 for implementation by a firewall on the respective devices 102. In other embodiments, the policy may be automatically generated. As illustrated, the devices 102 (and/or the administrator device 104) may be configured to communicate with the external sources 106 via one or more networks 108 to send and/or receive data (also referred to as “data traffic”). The one or more networks 108 may include any one or combination of multiple different types of networks, such as cellular networks, wireless networks, Local Area Networks (LANs), Wide Area Networks (WANs), Personal Area Networks (PANs), the Internet, and so on. In the example of FIG. 1, the administrator device 104 and the devices 102 form part of a Local Area Network (LAN) located within an office building, residence, etc., and the one or more networks 108 comprise another type of network (e.g., another LAN, a cellular network, a wireless network, a WAN, a PAN, the Internet, etc.). However, in other examples the administrator device 104 and/or the devices 102 may be configured in other contexts, as discussed below.

The administrator device 104 may be implemented as any type of computing device, such as one or more desktop computers, laptop computers, servers, smart phones, electronic reader devices, and so on. In some instances, any of the devices 102 may be configured as the administrator device 104 (e.g., the administrator device 104 may be the same as any of the devices 102). To illustrate, any of the devices 102 may enter an administrative mode when an individual logs-in to the device 102 with administrative credentials (e.g., an administrative username and password). When in the administrative mode, the device 102 (now the administrator device 104) may manage a firewall policy, as discussed herein. In other instances, the administrator device 104 comprises a dedicated computer that may or may not be the same as the devices 102. Further, although the administrator device 104 is discussed in the context of being located within a LAN (with respect to the devices 102), in some instances the administrator device 104 is configured in a cloud computing environment, cluster, data center, or a combination thereof. For example, the administrator device 104 may communicate with the devices 102 via the one or more networks 108.

The administrator device 104 may be equipped with one or more processors 110, memory 112, and/or one or more network interfaces 114. The one or more processors 110 may include a central processing unit (CPU), graphics processing unit (GPU), a microprocessor, and so on. Although not illustrated in FIG. 1, in some instances the administrator device 104 includes one or more displays, one or more sensors, etc. The one or more displays may include a Liquid-crystal Display (LCD), a Light-emitting Diode (LED) display, an organic LED display, a plasma display, an electronic paper display, or any other type of technology. The one or more sensors may include a proximity sensor that detects a proximity of objects to the device, an infrared (IR)/thermal sensor, a camera, a microphone, an accelerometer, a compass, a gyroscope, a magnetometer, a Global Positioning System (GPS), a depth sensor, an olfactory sensor (e.g., for smell), or other sensor. Further, the administrator device 104 may include or be associated with an input/output device, such as a keyboard, mouse, trackpad, monitor, speaker, printer, and so on.

The memory 112 of the administrator device 104 may include a firewall management module 116 (hereinafter “the FW management module 116”) that is executable by the one or more processors 110. The FW management module 116 may generally manage a policy associated with a firewall. For example, the FW management module 116 may provide a graphical user interface that includes controls (e.g., graphical elements—drop-down menus, input fields, etc.) usable by an administrator (e.g., individual, a group of people, or software) to define a policy 118. The administrator may provide input regarding rules for a component or type of component of a protocol layer (e.g., a group of rules for a particular component). Based on the input, the FW management module 116 may generate the policy 118 that includes the rules for the component or type of component, such as a group of rules for a particular IP interface(s), IP address(es), TCP port(s), socket(s), application(s), virtual network interface(s), Virtual Private Network (VPN), etc. The FW management module 116 may store the policy 118 in the memory 112, a data store (e.g., located on another device), or elsewhere. Additionally, or alternatively, the FW management module 116 may cause the policy 118 to be deployed to the devices 102, such as by sending the policy 118 to the devices 102, sending an instruction to a data store that includes the policy 118 instructing the data store to deploy the policy 118, and so on. In some instances, the FW management module 116 is implemented as part of an Operating System (OS), while in other instances the FW management module 116 is implemented within an application (e.g., a standalone application, a desktop application, a mobile application, etc.).

The device 102(N) is representative of any of the devices 102. The device 102(N) may comprise any type of computing device, such as a laptop computer, a desktop computer, a server, a smart phone, an electronic reader device, a mobile handset, a personal digital assistant (PDA), a portable navigation device, a portable gaming device, a video game console, a tablet computer, a watch, a portable media player, a wearable computing device (e.g., a watch, an optical head-mounted display (OHMD), etc.), a pair of head-mounted smart glasses (e.g., mixed reality head-mounted smart glasses), a motion sensing device, a television, a computer monitor or display, a set-top box, a computer system in a vehicle, an appliance, a camera, a robot, a hologram system, a security system, a thermostat, a smoke detector, an intercom, a home media system, a lighting system, a heating, ventilation and air conditioning (HVAC) system, a home automation system, a projector, an automated teller machine (ATM), and so on. In some instances, the computing device may comprise a mobile device, while in other instances the computing device may be a stationary device. Alternatively, or additionally, the device 102(N) may comprise any type of network device, such as a router, gateway, wireless access point, switch, hub, modem, repeater, network bridge, etc., or any type of hybrid network device, such as a protocol converter, bridge router, multiplexer, multilayer switch, network address translator, etc. As such, the device 102(N) may comprise any type of apparatus configured to send and/or receive data, such as a computing device, network device, hybrid network device, etc.

As illustrated, the device 102(N) may include a firewall 120 (shown as “FW 120” for ease of illustration). The firewall 120 may be implemented in hardware, software, or a combination thereof. As one example, the firewall 120 may be implemented as part of an Operating System (OS) or application (e.g., standalone software, integrated into another application, such as a Virtual Private Network (VPN) application, etc.). As another example, the firewall 120 may be embedded into a hardware device, such as a network device or hybrid network device. The firewall 120 may be implemented on a packet-by-packet basis (e.g., control each data packet), on a state-based manner (e.g., implemented when a flow is initiated over a connection and/or implemented periodically thereafter to check data traffic), and so on.

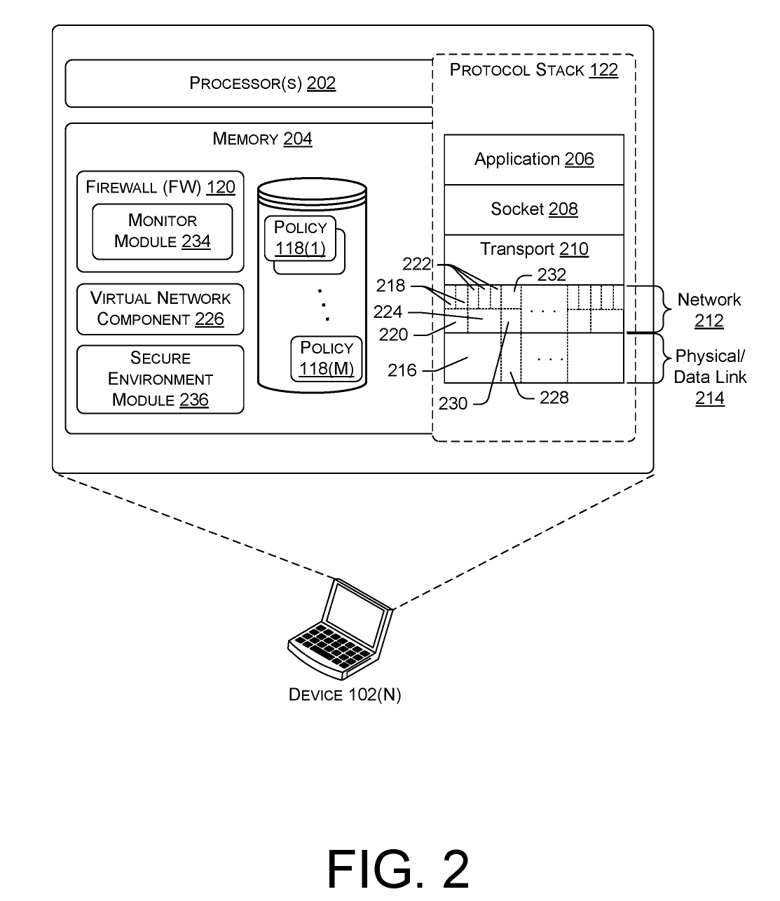

The firewall 120 may generally control data traffic to and/or from the device 102(N) according to the policy 118. The policy 118 may include rules to allow, block, or otherwise control data traffic being received and/or sent from the device 102(N). In some instances, the policy 118 may define a Quality of Service (QoS) for data traffic (e.g., rules defining a throughput for data traffic, such as a maximum throughput that is allowed). The policy 118 may include a set of rules for a component(s) or type of component within a layer of a protocol stack 122. For example, the policy 118 may include a group of rules that are tied to a specific IP interface within a network layer of the protocol stack 122. In this example, when data traffic reaches the network layer (e.g., to be sent out of the device 102(N) or upon receipt), the firewall 120 may be invoked to control the data traffic for the specific IP interface according to the group of rules. Thus, the firewall 120 and/or the policy 118 may be tied to a particular layer of the protocol stack 122. Alternatively, or additionally, the policy 118 may be tied to a particular data type, environmental context, etc. Although a single policy 118 is shown in FIG. 1, in some instances multiple policies are implemented. In some instances, the firewall 120 may control data traffic by requiring (e.g., forcing) the data traffic over a particular IP interface, IP address, etc. Further details of the device 102(N) will be discussed below in reference to FIG. 2.

As noted above, the device 102(N) may send data traffic to and/or receive data traffic from the external source 106. The external source 106 may include any type of device, service, etc. that is configured to provide data, such as a server, client device, data store, and so on. To illustrate, the external source 106 may be associated with an online service, online site, and so on.

Although the techniques are discussed in context of the example architecture 100 of FIG. 1, the techniques may be implemented in other contexts. In one example, a deployment service is implemented to store the policy 118 and/or deploy the policy 118 to the devices 102 within the architecture 100. In another example, the administrative device 104 and/or any of the devices 102 may be eliminated from the architecture 100. To illustrate, a single client device may include the firewall 120 that implements the policy 118. In yet another example, the firewall 120 and the policy 118 may be implemented within a network device anywhere within a network (e.g., the one or more networks 108). In further example, the techniques may be implemented in other contexts.

### Example Device

FIG. 2 illustrates example details of the device 102(N) of FIG. 1. The device 102(N) may be equipped with one or more processors 202 and memory 204. The one or more processors 202 may include a central processing unit (CPU), graphics processing unit (GPU), a microprocessor, and so on. Although not illustrated in FIG. 2, in some instances the device 102(N) includes one or more displays, one or more sensors, etc. The one or more displays may include a Liquid-crystal Display (LCD), a Light-emitting Diode (LED) display, an organic LED display, a plasma display, an electronic paper display, or any other type of technology. The one or more sensors may include a proximity sensor that detects a proximity of objects to the device, an infrared (IR)/thermal sensor, a camera, a microphone, an accelerometer, a compass, a gyroscope, a magnetometer, a Global Positioning System (GPS), a depth sensor, an olfactory sensor (e.g., for smell), or other sensor. Further, the device 102(N) may include or be associated with an input/output device, such as a keyboard, mouse, trackpad, monitor, speaker, printer, and so on.

The memory 204 (as well as the memory 112 of the administrator device 104 and all other memory described herein) may include one or a combination of computer-readable media. Computer-readable media may include computer storage media and/or communication media. Computer storage media includes volatile and non-volatile, removable and non-removable media implemented in any method or technology for storage of information, such as computer readable instructions, data structures, program modules, or other data. Computer storage media includes, but is not limited to, phase change memory (PRAM), static random-access memory (SRAM), dynamic random-access memory (DRAM), resistive random-access memory (ReRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave or other transmission mechanism. As defined herein, computer storage media (also referred to as “computer-readable storage media”) does not include communication media.

The software and/or hardware elements of the device 102(N) may send and/or receive data according to the protocol stack 122. The protocol stack 122 may represent a predetermined model, such as the Open System Interconnection (OSI) model, the Transmission Control Protocol (TCP)/IP model, the Internet model, etc. In this example, the protocol stack 122 may include several layers, such as an application layer 206, a socket layer 208 (e.g., session), a transport layer 210, a network layer 212, and a physical/data link layer 214. Although any number of layers may be present. In some instances, the protocol stack 122 may include a layer for http (e.g., between the socket layer 208 and the transport layer 210). The physical/data link layer 214 may be associated with various types of Network Interface Controllers (NICs) (also known as a network adapters), such as an Ethernet controller, wireless controller (e.g., Wi-Fi), cellular controller, fiber-based controller (e.g., for Fiber Distrusted Data Interface (FDDI)), and so on. This may allow the device 102(N) to connect to a network. Meanwhile, the network layer 212 may be associated with (i) IP interfaces for the various NICs of the physical/data link layer 214 and (ii) IP addresses for the IP interfaces. The transport layer 210 may connect to the IP interfaces via the IP addresses. The transport layer 210 may be associated with ports and protocols, such as TCP, User Datagram Protocol (UDP), or other protocols. The socket layer 208 may be associated with sockets. In one illustration, to connect to a NIC 216 at the physical/data link layer 214, an IP address may be selected at the network layer 212. In this example, two IP addresses 218 are associated with an IP interface 220 that represents IPv4, and three IP addresses 222 are associated with an IP interface 224 that represents IPv6. Although any number of IP addresses and/or IP interfaces may be used. In any event, an IP address may be selected from the IP addresses 218 or the IP addresses 222, and then either the IP interface 220 or the IP interface 224, depending on the IP address that is selected.

The memory 204 of the device 102(N) may also include a virtual network component 226 that is executable by the one or more processors 202 to facilitate a VPN. The VPN may connect the device 102(N) with another system, connect an element of the device 102(N) with another element, and so on. In many instances, a VPN is associated with its own NIC, IP interface, and IP address, illustrated as NIC 228, IP interface 230, and IP address 232. As noted above, in some instances the firewall 120 may control data over a VPN, such as by requiring (e.g., forcing) enterprise applications to use a VPN and requiring user applications to use another connection. In some instances, if a VPN is not connected, and data traffic is required to be sent/received over the VPN, then the firewall 120 may block the data traffic. This may help maintain a more secure environment for business data associated with the enterprise applications. As such, the firewall 120 may, in some instances, control data traffic by forcing the data traffic over a particular IP interface associated with a VPN.

The device 102(N) may include the firewall 120 to control data traffic to and/or from the device 102(N). In the example of FIG. 2, the firewall 120 is implemented as a software element that is stored in the memory 204 and executable by the one or more processors 202. However, as noted above, in other examples the firewall 120 may be implemented in hardware or a combination of hardware and software. For example, the functions of the firewall 120 may be performed by a NIC or other hardware element. As illustrated in this example, the firewall 120 may be implemented as part of device 102. Alternatively, or additionally, the firewall 120 may be a device that controls network access to the device 102. The firewall 120 may implement any of the policies 118(1)-118(M) (collectively referred to as “the policies 118”). M may be an integer greater than “0.” Each of the policies 118 may include a set of rules that are specific to a particular component(s) of a protocol layer, such as a particular IP interface(s), IP address(es), TCP port(s), socket(s), application(s), virtual network interface(s), Virtual Private Network (VPN), etc. The rules may be based on various properties associated with data traffic. As such, the firewall 120 may control data traffic based on the various properties of the data traffic. Example properties include:
Source IP address for data traffic;
Destination IP address for data traffic;
IP protocol for data traffic;
Source TCP port number for data traffic;
Destination TCP port number for data traffic;
Source UDP port number for data traffic;
Destination UDP port number for data traffic;
Sending application of data traffic (which may be based on an application identifier (ID));
Receiving application of data traffic (which may be based on an application identifier (ID));
Security descriptors for data traffic (e.g., such as access control information indicating an entity/user that owns data (e.g., an object), an entity/user that is authorized (or not authorized) to access data, how data can be accessed, a type of access that is audited, and so on);
Etc.

In some instances, when a rule is based on the source IP address, destination IP address, IP protocol, source TCP port, and source UDP port the rule is referred to as a 5-tuple rule. Further, in some instances a rule may be defined for a range of ports, IP addresses, sockets, and so on. Moreover, in some instances either TCP or UDP are used as a transport (e.g., an application uses either TCP to send/receive data or UDP to send/receive data).

In one illustration, the firewall 120 may implement a policy that is tied to the network layer 212 of the protocol stack 122 (e.g., IP interfaces). In this illustration, when data traffic is received at the network layer 212 (as outbound or inbound traffic), the firewall 120 may be invoked (e.g., called) to control the data traffic. In particular, the firewall 120 may select a policy that is specific to the network layer 212 (e.g., includes a set rules that are tied to the network layer 212). For instance, the rules may specify:
For the IP interface 220 (associated with IPv4):
   rule 1—allow data traffic associated with source IP addresses 104.43.5.5 or 104.43.4.2;
   rule 2—block data traffic associated with TCP ports 34 or 25;
   rule 3—allow data traffic associated with applications A or B;
For the IP interface 230 (associated with the Virtual Network Component 226):
   rule 1—allow data traffic associated with source IP addresses 23.74.5.5 or 23.74.4.2;
   rule 2—block data traffic associated with TCP ports 34 or 25;
   rule 3—allow data traffic associated with applications C or D.

Here, the example rules force data traffic for applications A and B over the IP interface 220 and data traffic for applications C and D over the IP interface 230, assuming that the other criteria for the rules are satisfied. In this illustration, the firewall 120 may analyze properties of the data traffic received at the network layer 212 based on the policy that is specific to the network layer 212 to determine how the data is to be transferred (if at all). For this illustration, assume that the data traffic is associated with a source IP address 104.43.5.5, a TCP port number 45, and an application A. Thus, the firewall 120 would determine to pass the data traffic over the IP interface 220.

In another illustration, the firewall 120 may implement a policy that is tied to the application layer 206 of the protocol stack 122 (e.g., applications of the application layer 206). Here, when data traffic is received or designated to be sent at the application layer 206 (as outbound or inbound traffic), the firewall 120 may be invoked (e.g., called) to control the data traffic. In particular, the firewall 120 may select a policy that is specific to the application layer 206. For instance, the rules may specify:
For applications categorized as enterprise applications (e.g., word processing applications, spreadsheet applications, enterprise email applications, or other applications generally associated with business data):
   rule 1—allow data traffic associated with source IP addresses 23.74.4.4 or 23.74.5.2;
   rule 2—allow data traffic over IP interface 230 that is associated with a VPN;
For applications categorized as user applications (e.g., social media applications, news applications, e-commerce applications, etc.):
   rule 1—allow data traffic associated with source IP addresses 104.42.4.4 or 104.42.5.2;
   rule 2—allow data traffic over an IP interface that is associate with a wireless NIC or an IP interface that is associated with an Ethernet NIC.

Here, the example rules force data traffic for enterprise applications over the IP interface associated with the VPN and force data traffic for user applications over the IP interface associated with a wireless or Ethernet NIC, assuming that the other criteria for the rules are satisfied. In this illustration, the firewall 120 may analyze properties of the data traffic that is received at the application layer 206 based on the policy that is specify to the application layer 206 to determine how the data is to be transferred (if at all). For this illustration, assume that the data traffic is associated with a source IP address 23.74.4.4 and an enterprise application. Thus, the firewall 120 would determine to pass the data traffic over the IP interface associated with the VPN.

In some instances, the firewall 120 may control data traffic based on application specific information, such as an application identifier, metadata associated with data traffic other than that being sent in a packet, and so on. The application specific information may be passed to the firewall 120 as data is being sent or received. For example, the firewall 120 may receive data traffic to be sent over a network from an application and metadata for the data traffic. The metadata may include an application identifier identifying the application. By receiving such information at the application layer, the firewall 120 may identify the application associated with the data traffic and control data traffic at a more granular level of detail and/or in a more customized manner.

Although many examples discuss the firewall 120 implementing a single policy, in some instances multiple policies may be implemented at different layers of the protocol stack 122. For example, a first policy may be implemented for a particular IP address (including a group of rules for the particular IP address), while another policy may be implemented at the application layer for a particular type of application.

In some embodiments, the firewall may be integrated with software deployment. Software applications that run on the device 102 may take certain actions (e.g. installation, placement, activation, deactivation, update, etc.) that will result in a policy update. There may be one or more inputs to the policy update including, but not limited to, input from an administrator, input from the software application, and input from local configuration. In some embodiments, the firewall 120 may also include the ability to generate and apply policy based on locally monitoring one or more local events such as the software application type, the device location, the user identity. Additionally, or alternatively, the firewall 120 may have the ability to calculate policy by applying a default policy, and/or based on any combination of the above inputs.

A policy model in accordance with embodiments described herein may enable more efficient policy management and application. By implementing a policy model that is tied to one or more components of a protocol stack, policies may be created, read, updated, or deleted in a more streamlined and/or unified manner. For example, rules are referenced based on a specific data type, such as IP interface or software application, as a result, fewer rules need to be considered as part of policy management and application.

As illustrated in FIG. 2, the firewall 120 may include a monitor module 234 configured to determine environmental context of the device 102(N), such as a geo-location of the device 102(N), a connection of the device 102(N) to a network, a user that is using the device 102(N) (e.g., logged in) (also referred to as user identity), and so on. The firewall 120 may use the environmental context to select a policy, from among the plurality of policies 118. For example, as the device 102(N) changes location and/or connects to different networks (e.g., a public network, home network, etc.), the environmental context of the device 102(N) may change. If the device 102(N) is configured to use different policies for the different environmental contexts, then the firewall 120 may select a policy that is applicable to the current environmental context. Thereafter, if the environmental context changes, a new policy may be selected. This may allow different types of policies to be implemented in different contexts (e.g., a more stringent policy on a public network and a less stringent policy on a home network). In some instances where the device 102(N) is associated with a policy for an environmental context, the firewall 120 may check an environmental context of the device 102(N) and/or select the policy when the device 102(N) attempts to send/receive network traffic, when the device 102(N) connects to a network, and so on.

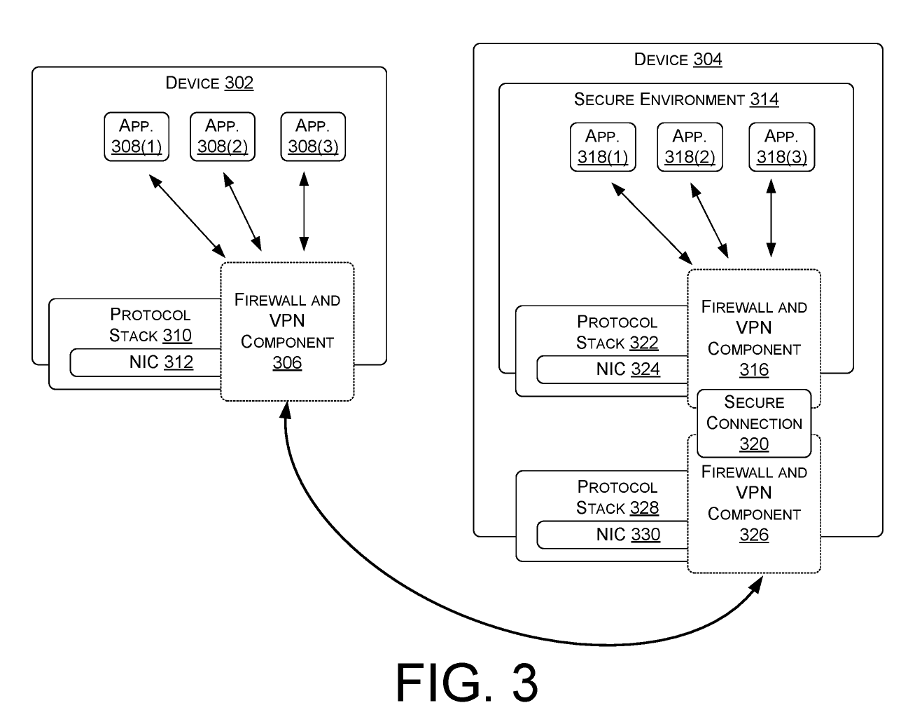

Further, the memory 204 may include a secure environment module 236 that is executable by the one or more processors 202 to create a secure environment, such as a Virtual Machine (VM), container, and so on. In some instances, a secure environment is created within the device 102(N) and the firewall 120 is implemented to control data traffic between the secure environment and the other elements of the device 102(N). This may isolate the secure environment from the other elements of the device 102(N), as discussed in further detail below in reference to FIG. 3.

### Example Isolation Systems

FIG. 3 shows example isolation systems in which the techniques discussed herein may be implemented. Here, a device 302 may communicate with a device 304 over a Virtual Private Network (VPN). In this example, the device 302 implements a combined firewall and VPN component 306 to control data traffic data traffic for applications 308(1)-308(3) over the VPN. Although illustrated as combined, the firewall and VPN component 306 may be implemented separately. The firewall and VPN component 306 may implement a policy for a particular component(s) of a protocol stack 310, including a Network Interface Controller (NIC) 312. In particular, the policy may specify which applications of the applications 308 are allowed or required to communicate with the device 304 over the VPN.

The device 304 includes a secure environment 314 nested within the device 304 to illustrate how the techniques operate within a nested system. Here, the secure environment 314 includes a Virtual Machine (VM) or container implementing a combined firewall and VPN component 316 to control data traffic for applications 318(1)-318(3) over a secure connection 320 (e.g., a VPN). Although illustrated as combined, the firewall and VPN component 316 may be implemented separately. The firewall and VPN component 316 may implement a policy for a particular component(s) of a protocol stack 322, including a Network Interface Controller (NIC) 324. In particular, the policy may specify which applications of the applications 318 are allowed or required to communicate over the secure connection 320. The secure connection 320 may comprise a VPN between the secure environment 314 and the device 304. As illustrated, a firewall and VPN component 326 for the device 304 may implement a policy for a particular component(s) of a protocol stack 328, including a Network Interface Controller (NIC) 330. In particular, the policy may specify how to control data traffic over the VPN with the device 302.

As illustrated in FIG. 3, the techniques may enable systems to be isolated from each other (e.g., by isolating network interfaces). In other instances, other types of systems may be isolated, such as isolating a kernel from the rest of the Operating System (OS), isolating systems that are nested behind Network Address Translation (NAT), and so on.

In some instances of a nested system(s), a single firewall may implement two or more firewall policies for nested systems. For example, the firewall and VPN component 326 of the device 304 (e.g., the host) may implement a policy that is defined for the secure environment 314 and a policy that is defined for the device 304. Alternatively, or additionally, multiple firewalls may be implemented at each of the levels of a nested system.

### Example Processes

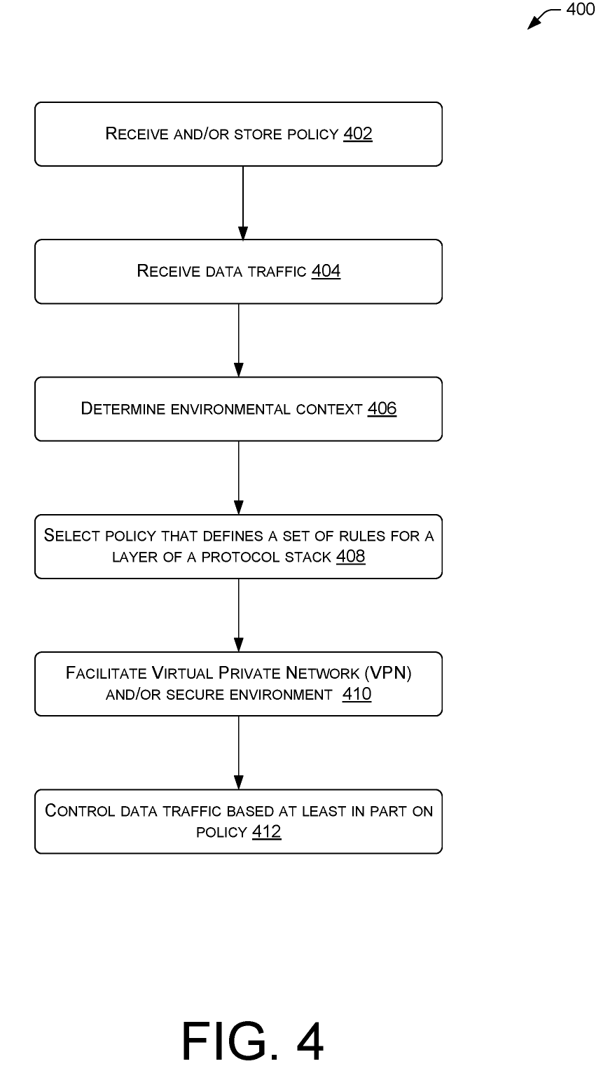

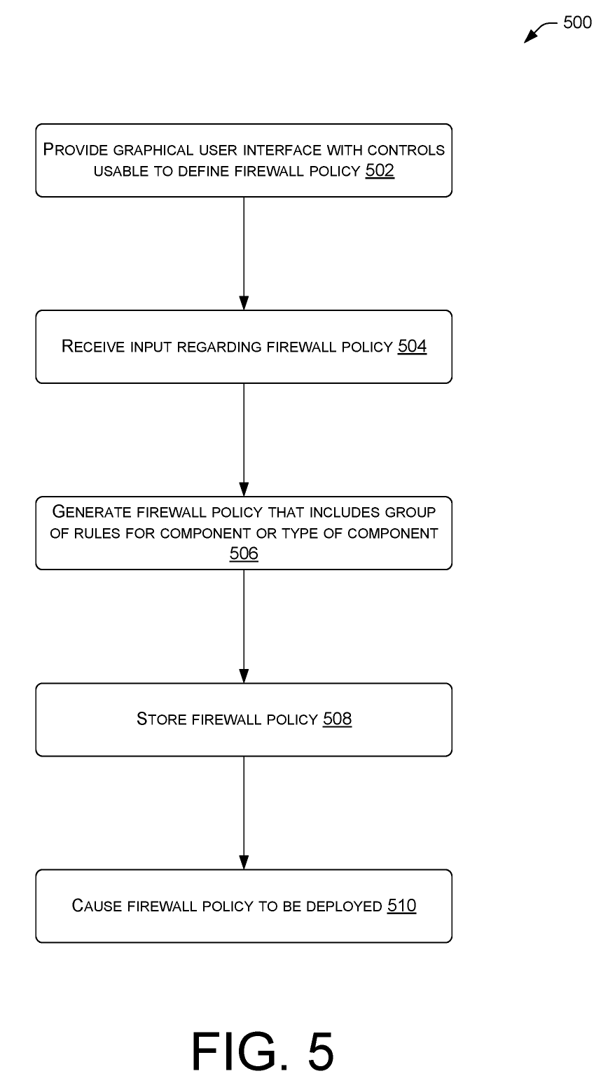

FIGS. 4 and 5 illustrate example processes 400 and 500 for employing the techniques described herein. For ease of illustration the processes 400 and 500 are described as being performed in the architecture 100 of FIG. 1. For example, one or more of the individual operations of the processes 400 and 500 may be performed by any of the devices 102, the administrator device 104, and so on. However, the processes 400 and 500 may be performed in other architectures. Moreover, the architecture 100 may be used to perform other processes.

The processes 400 and 500 (as well as each process described herein) are illustrated as a logical flow graph, each operation of which represents a sequence of operations that can be implemented in hardware, software, or a combination thereof. The order in which the operations are described is not intended to be construed as a limitation, and any number of the described operations can be combined in any order and/or in parallel to implement the process. Further, any of the individual operations may be omitted. In the context of software, the operations represent computer-executable instructions stored on one or more computer-readable media that, when executed by one or more processors, configure the one or more processors to perform the recited operations. Generally, computer-executable instructions include routines, programs, objects, components, data structures, and the like that perform particular functions or implement particular abstract data types. In some instances, in the context of hardware the operations may be implemented in whole or in part by one or more hardware logic components to execute the described functions. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

FIG. 4 illustrates the example process 400 to control data traffic based on a policy that includes a set of rules that are applicable to a particular component(s) of a layer of a protocol stack.

At 402, an apparatus (e.g., the device 102(N) of FIG. 1) may receive and/or store a policy for a firewall. The policy may be received from an administrator device 104, a deployment service, or any other device. The policy may also be locally configured. The policy may define a set of rules for a component or type of component of a layer of a protocol stack. The component may comprise an IP interface(s), IP address(es), TCP port(s), socket(s), application(s), virtual network interface(s), Virtual Private Network (VPN), etc. As one example, the policy defines a group of rules of different types (e.g., some related to IP addresses, some related to TCP ports, etc.) for a category of an application. In some illustrations, a category of an application may dynamically change based on behaviors of the application (e.g., change from a first category to a second category when a different type of data traffic is being sent/received). In other illustrations, a category of an application may remain the same. As another example, the policy defines a group of different types of rules for a particular IP interface. In some instances, the policy defines a group of rules for a group of components. Further, in some instances the policy specifies an application that is authorized to communicate over a VPN,

At 404, data traffic may be received. This may include receiving the data traffic at a particular layer of a protocol stack (e.g., a layer associated with a component or type of component within a policy) from another layer of the protocol stack. For example, a network layer of a protocol stack may receive data traffic. Alternatively, or additionally, this may include receiving data traffic at the apparatus from another system.

At 406, the apparatus may determine environmental context associated with the apparatus. The environmental context may comprise a geo-location of the apparatus (e.g., determined by a Global Positioning System (GPS) sensor), a connection of the apparatus to a network (e.g., determined by an IP address of a network device, etc.), the identity of the user that is logged into the device, and so on.

At 408, the apparatus may select a policy that defines a set of rules for a layer of a protocol stack. In some instances, operation 408 may be performed in response to or based on receiving data traffic at operation 404. In other instances, operation 408 may be performed at other times. When selecting a policy, the apparatus (e.g., a firewall of the apparatus) may choose from among multiple policies, such as policies that are associated with different environmental contexts, different layers or components of a protocol stack, and so on. For example, a first policy that is associated with a first layer of a protocol stack may be selected when data is received at the first layer. Further, in some instances a different policy may be selected upon detecting that an environmental context has changed.

At 410, the apparatus may facilitate a VPN and/or a secure environment. This may include creating and/or maintaining the VPN and/or the secure environment. The secure environment may include a virtual machine or a container within the apparatus. In some instances, a secure environment is created within another secure environment (e.g., nested environments). The VPN may be created between the secure environment and the apparatus, nested secure environments within the apparatus, the apparatus and an external system, and so on.

At 412, the apparatus may control data traffic based on a policy. Operation 412 may be performed by a firewall of the apparatus. The data traffic may be controlled when the data is received at a layer or component that is associated with a policy. Thus, the firewall may control data traffic through the layer. As one example, operation 412 may include determining that data traffic satisfies a set of rules to be sent or received via a particular IP interface and causing the data traffic to be sent or received via the particular IP interface. As another example, operation 412 may include determining that data traffic is from, or designated to be sent to, an application that is associated with a predetermined application category and controlling the data traffic based on a set of rules for the predetermined application category. In some instances, operation 412 may control data traffic over a VPN.

FIG. 5 illustrates the example process 500 to generate a policy that includes a set of rules that are applicable to a particular component(s) of a layer of a protocol stack.

At 502, a computing device (e.g., the administrator device 104 of FIG. 1) may provide a graphical user interface with controls usable to define a firewall policy. For example, the graphical user interface may include graphical elements so that an administrator may provide input to define rules of a firewall policy. Although a graphical user interface is discussed, in some instances another type of interface may be provided, such as a command line interface. In some embodiments, the firewall may automatically identify input sources including, but not limited to input from the software application, input from local configuration, input from local events such as the software application type, the device location, and/or the user identity

At 504, the computing device may receive input regarding a firewall policy. The input may identify a group of rules for a component or type of component of a protocol layer, such as a group of rules for a group of Internet Protocol (IP) interfaces, a group of rules for a group of applications, and so on. In some instances, a group of applications may include applications that are associated with a same category. In one illustration, input may be provided to associate a group of rules with a particular category of applications. As applications associated with the particular category are deployed on a device, a group of applications that are associated with the particular category may dynamically change on the device.

At 506, the computing device may generate a firewall policy. Operation 506 may be based on input received at 504. The firewall policy may include a group of rules for a component or type of component of a protocol layer.

At 508, the computing device may store a firewall policy. This may include storing the firewall policy locally at the computing device, storing the policy at a remote data store (e.g., deployment service), and so on.

At 510, the computing device may cause a firewall policy to be deployed. This may include sending the firewall policy to devices to be implemented at the devices by respective firewalls, sending an instruction to a deployment service instructing the deployment service to send the firewall policy to the devices, and so on.

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

### Example Clauses

Example A, an apparatus comprising: one or more processors; memory communicatively coupled to the one or more processors and configured to store a first policy that defines a set of rules for an Internet Protocol (IP) interface from among a plurality of IP interfaces associated with a network layer of a protocol stack; and a firewall configured to: in response to receiving data traffic at the network layer of the protocol stack, select the first policy that defines the set of rules for the IP interface; and control the data traffic based at least in part on the first policy.

Example B, the apparatus of example A, wherein the firewall is configured to control the data traffic by: determining that the data traffic satisfies the set of rules to be sent or received via the IP interface; and causing the data traffic to be sent or received via the IP interface based at least in part on the determining.

Example C, the apparatus of example A or B, wherein the firewall is further configured to: in response to receiving the data traffic at an application layer of the protocol stack, select a policy that defines a set of rules for the application layer; and control the data traffic to or from the application layer based at least in part on the selected policy that defines the set of rules for the application layer.

Example D, the apparatus of any of examples A-C, wherein the selected policy defines a set of rules for a predetermined application category.

Example E, the apparatus of any of examples A-D, wherein the firewall is configured to control the data traffic to or from the application layer by: determining that the data traffic is from, or designated to be sent to, an application that is associated with the predetermined application category; and controlling the data traffic to or from the application layer based at least in part on the set of rules for the predetermined application category.

Example F, the apparatus of any of examples A-E, wherein the firewall is configured to select the policy based at least in part on environmental context, the environmental context comprising at least one of a geo-location of the apparatus, a connection of the apparatus to a network, or a user identity.

Example G, the apparatus of any of examples A-F, further comprising: a Virtual Private Network (VPN) component; wherein the set of rules of a second policy specifies an application that is authorized to communicate over the VPN component, and wherein the firewall is configured to control the data traffic by: determining whether or not the data traffic is from, or designated to be sent to, the application; and controlling the data traffic based on the second policy.

Example H, the apparatus of any of examples A-G, further comprising: at least one of a virtual machine, a container, or both; wherein the firewall is configured to control data traffic to or from the at least one of a virtual machine, a container, or both based at least in part on a second policy.

Example I, a method comprising: storing, by a computing device, a firewall policy that defines a set of rules for an Internet Protocol (IP) interface from among a plurality of IP interfaces associated with a network layer of a protocol stack; in response to receiving data traffic at the network layer of the protocol stack, selecting, by the computing device, the firewall policy that defines the set of rules for the IP interface; and controlling, by the computing device, the data traffic based at least in part on the firewall policy.

Example J, the method of example I, further comprising: providing a graphical user interface to define a firewall policy; receiving, via the graphical user interface, input regarding a group of rules for a group of Internet Protocol (IP) interfaces; generating the firewall policy based at least in part on the input, the firewall policy including the group of rules for the group of IP interfaces; and storing, by the computing device, the firewall policy for deployment to one or more devices.

Example K, the method of any of examples I or J, receiving input regarding a group of rules for a group of applications; and generating a firewall policy that includes the group of rules for the group of applications; and storing the firewall policy for deployment to one or more devices.

Example L, the method of any of examples I-K, wherein the selected policy defines a set of rules for a predetermined application category.

Example M, a system comprising: one or more processors; and memory communicatively coupled to the one or more processors and storing executable instructions that, when executed by the one or more processors cause the one or more processors to perform the method of any of examples I-K.

Example N, an apparatus comprising: one or more processors; memory communicatively coupled to the one or more processors and configured to store a firewall policy that includes a set of rules for a group of applications associated with a predetermined category, the set of rules for the group of applications comprising multiple rules of different types; and a firewall configured to: determine that data traffic is from, or designated to be sent to, an application that is associated with the predetermined category; and control the data traffic based at least in part on the set of rules for the group of applications associated with the predetermined category.

Example O, the apparatus of example N, wherein the firewall is configured to: determine that an application has been deployed; and in response to determining, updating a firewall policy for the deployed application.

Example P, the apparatus of example N or O, wherein the firewall is configured to select the firewall policy based at least in part on environmental context, the environmental context comprising a geo-location of the apparatus.

Example Q, the apparatus of any of examples N-P, wherein the firewall is configured to select the firewall policy based at least in part on environmental context, the environmental context comprising a user identity.

Example R, the apparatus of any of examples N-Q, wherein the firewall is configured to select the firewall policy based at least in part on environmental context, the environmental context comprising a connection of the apparatus to a network.

Example S, the apparatus of any of examples N-R, wherein the firewall is configured to: detect that an environmental context has changed, the environmental context comprising at least one of a geo-location of the apparatus, a user identity, or a connection of the apparatus to a network; select a further firewall policy; and control other data traffic based at least in part on the further firewall policy.

Example T, the apparatus of any of examples N-S, further comprising: a Virtual Private Network (VPN) component; wherein the set of rules for the group of applications specify that the group of applications that are associated with the predetermined category are authorized to communicate over the VPN component, and wherein the firewall is configured to control the data traffic by causing the data traffic to be sent or received via the VPN component.

Example U, the apparatus of any of examples N-T, wherein the firewall is configured to generate a firewall policy based in part on input received via a graphic user interface, input from a software application, information related to local configuration, local events including a software application type, or environmental context.

Example V, one or more computer storage media storing computer-readable instructions that, when executed, instruct one or more processors to perform operations of any of examples A-U.

What is claimed is:

1. An apparatus comprising:
one or more processors;
memory communicatively coupled to the one or more processors and configured to store a first policy that defines a set of rules for an Internet Protocol (IP) interface from among a plurality of IP interfaces associated with a network layer of a protocol stack; and
a firewall configured to:
in response to receiving data traffic at the network layer of the protocol stack, select the first policy that defines the set of rules for the IP interface; and
control the data traffic based at least in part on the first policy.

2. The apparatus of claim 1, wherein the firewall is configured to control the data traffic by:
determining that the data traffic satisfies the set of rules to be sent or received via the IP interface; and
causing the data traffic to be sent or received via the IP interface based at least in part on the determining.

3. The apparatus of claim 1, wherein the firewall is further configured to:
in response to receiving the data traffic at an application layer of the protocol stack, select a policy that defines a set of rules for the application layer; and
control the data traffic to or from the application layer based at least in part on the selected policy that defines the set of rules for the application layer.

4. The apparatus of claim 3, wherein the selected policy defines a set of rules for a predetermined application category.

5. The apparatus of claim 4, wherein the firewall is configured to control the data traffic to or from the application layer by:
determining that the data traffic is from, or designated to be sent to, an application that is associated with the predetermined application category; and
controlling the data traffic to or from the application layer based at least in part on the set of rules for the predetermined application category.

6. The apparatus of claim 1, wherein the firewall is configured to select the policy based at least in part on environmental context, the environmental context comprising at least one of a geo-location of the apparatus, a connection of the apparatus to a network, or a user identity.

7. The apparatus of claim 1, further comprising:
a Virtual Private Network (VPN) component;
wherein the set of rules of a second policy specifies an application that is authorized to communicate over the VPN component, and wherein the firewall is configured to control the data traffic by:
determining whether or not the data traffic is from, or designated to be sent to, the application; and
controlling the data traffic based on the second policy.

8. The apparatus of claim 1, further comprising:
at least one of a virtual machine, a container, or both;
wherein the firewall is configured to control data traffic to or from the at least one of a virtual machine, a container, or both based at least in part on a second policy .

9. A method comprising:
storing, by a computing device, a firewall policy that defines a set of rules for an Internet Protocol (IP) interface from among a plurality of IP interfaces associated with a network layer of a protocol stack;
in response to receiving data traffic at the network layer of the protocol stack, selecting, by the computing device, the firewall policy that defines the set of rules for the IP interface; and
controlling, by the computing device, the data traffic based at least in part on the firewall policy.

10. The method of claim 9, further comprising:
providing a graphical user interface to define a firewall policy;
receiving, via the graphical user interface, input regarding a group of rules for a group of Internet Protocol (IP) interfaces;
generating the firewall policy based at least in part on the input, the firewall policy including the group of rules for the group of IP interfaces; and
storing, by the computing device, the firewall policy for deployment to one or more devices.

11. The method of claim 9, further comprising:
receiving input regarding a group of rules for a group of applications; and
generating a firewall policy that includes the group of rules for the group of applications; and
storing the firewall policy for deployment to one or more devices.

12. The method of claim 9, wherein the selected policy defines a set of rules for a predetermined application category.

13. An apparatus comprising:
one or more processors;
memory communicatively coupled to the one or more processors and configured to store a firewall policy that includes a set of rules for a group of applications associated with a predetermined category, the set of rules for the group of applications comprising multiple rules of different types; and
a firewall configured to:
determine that data traffic is from, or designated to be sent to, an application that is associated with the predetermined category; and
control the data traffic based at least in part on the set of rules for the group of applications associated with the predetermined category.

14. The apparatus of claim 13, wherein the firewall is configured to:
determine that an application has been deployed; and
in response to determining, updating a firewall policy for the deployed application.

15. The apparatus of claim 13, wherein the firewall is configured to select the firewall policy based at least in part on environmental context, the environmental context comprising a geo-location of the apparatus.

16. The apparatus of claim 13, wherein the firewall is configured to select the firewall policy based at least in part on environmental context, the environmental context comprising a user identity.

17. The apparatus of claim 13, wherein the firewall is configured to select the firewall policy based at least in part on environmental context, the environmental context comprising a connection of the apparatus to a network.

18. The apparatus of claim 13, wherein the firewall is configured to:
detect that an environmental context has changed, the environmental context comprising at least one of a geo-location of the apparatus, a user identity, or a connection of the apparatus to a network;
select a further firewall policy; and
control other data traffic based at least in part on the further firewall policy.

19. The apparatus of claim 13, further comprising:
a Virtual Private Network (VPN) component;
wherein the set of rules for the group of applications specify that the group of applications that are associated with the predetermined category are authorized to communicate over the VPN component, and wherein the firewall is configured to control the data traffic by causing the data traffic to be sent or received via the VPN component.

20. The apparatus of claim 13, wherein the firewall is configured to generate a firewall policy based in part on input received via a graphic user interface, input from a software application, information related to local configuration, local events including a software application type, or environmental context.
